(19) United States
(12) Patent Application Publication
(10) Pub. No.: US 2018/0188081 A1
(43) Pub. Date: Jul. 5, 2018

(54) SYSTEM FOR DETERMINING AND MONITORING AT LEAST ONE PROCESS VARIABLE OF A MEDIUM

(71) Applicant: Endress+Hauser Conducta GmbH+Co. KG, Gerlingen (DE)

(72) Inventors: Matthias Altendorf, Lorrach (DE); Detlev Wittmer, Maulbronn (DE)

(21) Appl. No.: 15/850,573

(22) Filed: Dec. 21, 2017

(30) Foreign Application Priority Data
Dec. 29, 2016 (DE) 10 2016 125 871.7

(51) Int. Cl. G01D 5/353; G01N 21/27; G01N 21/25

(52) U.S. Cl. CPC G01D 5/35316; G01N 21/27; G02B 6/4206; G01N 2201/088; G01N 21/255

(57) ABSTRACT

A system for determining a process variable of a medium arranged in a container is disclosed, including an optical fiber Bragg sensor with an optical waveguide with a fiber Bragg grating, a signal generating unit designed to generate an optical input signal and couple it into the waveguide, a receiving unit designed to receive an optical output signal from the waveguide and converts it into an electrical output signal, and an evaluating unit which determines the process variable using the electrical output signal, wherein a subsection of the optical waveguide is arranged inside or in a wall of the container, the subsection designed such that the fiber Bragg grating is affected by the process variable to be determined of the medium.

### CROSS-REFERENCE TO RELATED APPLICATION

The present application is related to and claims the priority benefit of German Patent Application No. 10 2016 125 871.7, filed on Dec. 29, 2016, the entire contents of which are incorporated herein by reference.

### TECHNICAL FIELD

The present disclosure relates to a system for determining or monitoring at least one process variable of a medium.

### BACKGROUND

Spectrometric measurements in media particularly in gases, liquids, solids, and multiphase mixtures provide information about the current condition and/or composition of the respective medium. In process automation, spectrometric analyses of media are preferably used if, during a production or distillation process, the quantity, concentration, or quality of a substance formed in the process as an intermediate or end product must be monitored. For example, in a biochemical production process, concentrations of nutrients, and/or concentrations of metabolites of the microorganisms used in the production process, and/or the concentration of the intermediate or end product produced in the production process can be monitored. Based upon the information obtained spectrometrically, the production process can be controlled or regulated. During the production process, the medium itself is generally located in a container, e.g., a reactor, a fermenter, or a pipeline.

A spectrometric method very well-suited for analyzing and monitoring gaseous, liquid, and solid media is Raman spectroscopy. It is based upon the inelastic scattering, called the Raman effect, of electromagnetic excitation radiation by atoms or molecules. As a consequence of the inelastic scattering, an energy transfer between the excitation radiation and the interacting particles of the medium (atoms, molecules) results. The energy is transferred either from the radiation to the particles (Stokes scattering) or from the particles to the electromagnetic radiation (anti-Stokes scattering). The scattered radiation thus has a lower energy or a higher energy than the excitation radiation. A Raman spectrum shows the intensity of the scattered radiation as a function of its frequency difference from the excitation radiation (generally specified in wave numbers, cm⁻¹). Raman spectroscopy is a vibrational spectroscopy, i.e., the energy transfers detected using Raman spectroscopy correspond to characteristic vibration energy levels of atoms in the crystal lattice, or of molecules or of functional groups of molecules. Thus, based upon certain peaks, or bands, in the Raman spectrum, the presence of certain molecules in the medium, for example, and, based upon the intensity of the respective peaks, or bands, the concentration of the molecules in the medium can be determined.

Particular advantages are provided by Raman spectroscopy in analyses of aqueous process media especially, biological systems or biotechnological processes since water is a very weak Raman scatterer so that Raman signals of molecules dissolved in water can be seen easily in the Raman spectrum. In addition, Raman spectroscopy does not require any additional preparation of the sample and can provide measured values in a short time. This method is therefore especially attractive for process analysis and process control.

In the prior art, it is common to take samples of a process medium from the process container and to analyze them in the laboratory by means of Raman spectroscopy. The Raman spectra are analyzed by means of a data processing unit, such as a conventional computer. The sampling as such is problematic, and also entails a few disadvantages; for example, a time delay between the time of the taking of a sample from the process container and the analysis in the laboratory necessarily results, since known Raman spectrometers are suitable for use in the process only to a limited extent. Moreover, a proper and sterile taking of samples from processes to be kept sterile, e.g., in food technology, in processes of the pharmaceutical industry, and/or of biotechnology, is associated with a high investment in equipment and personnel. Depending upon the type of process, a health hazard can also exist during the sampling, if, for example, an undesired contact of the sample or of the process medium with the environment or the operator should occur. Naturally, what is particularly problematic in this context is the taking of samples from processes that inherently carry a high risk potential. This risk can, for example, arise from harmful radiation, a dusty atmosphere, or simply from the medium located in the process being accessible only with difficulty for example, due to the dimensioning of the container. Raman spectroscopy can also be used only for analysis purposes; it is not able to provide information about other physical or chemical process variables.

A pre-assembled, in-line measuring device is known from DE 10 2013 103 518 A1 (E+H), which describes a first measuring sensor for spectrometrically determining the concentration of at least one component of a medium flowing in a pipeline by means of an optical measuring principle. The first measuring sensor is integrated into a measuring tube, which comprises a pipeline section. This pipeline section is designed such that it can subsequently be integrated into the pipeline. The pre-assembly and calibration of the in-line measuring device preferably take place at the factory.

It is furthermore known to determine physical or chemical process variables by means of fiber-optic sensors. Fiber-optic sensors use optical waveguides to guide the measuring radiation or the light. An optical waveguide consists of a core and a cladding. Fiber-optic sensors have some advantages; for example, they are largely insensitive to external electromagnetic interfering fields, and their use is also possible in the high temperature range. As a result of their small dimensioning, fiber-optic sensors also have the advantage that information about various process variables can be obtained by multiplexing from several sensors provided in at least one fiber.

The fiber-optic sensors are preferably based upon the fiber Bragg method. In these sensors, at least one fiber Bragg grating (FBG) is inscribed into the optical waveguide. An FBG is produced by a periodic modulation of the refraction index of the refractive index of the core of the optical waveguide and has the function of an optical interference filter; wavelengths of the light that are located within the filter bandwidth around the Bragg wavelength are reflected. In doing so, the effective refraction index depends both upon the geometries and the refraction indices of the core and cladding and upon the wave modes.

As a signal generating source, a broadband light source or a tunable laser is used that continuously passes through a certain wavelength range, in which the Bragg wavelengths of the FBG's to be detected are located.

The detection and analysis of the Bragg wavelength(s) are carried out either by wavelength division multiplexing (WDM) or by time division multiplexing (TDM). In WDM, the different center wavelengths of the individual bandwidths of the FBG's are used as a wavelength-coded signal, while, in the TDM method, the different transit times of the light due to the various distances of the FBG's and the detector are used. In the TDM method, all FBG sensors in an optical fiber can have the same Bragg wavelength, since the positions of the individual FBG's are known over the transit time of the light, and since the change in the Bragg wavelength can be determined at the same time via a wavelength decoder. With the WDM method, a higher resolution can be achieved than with the TDM method. The sensors can also be arranged, one after the other, at very short intervals. As an example of a measuring device for detecting and analyzing FBG measurement signals, an optical spectrum analyzer (OSA) must be mentioned. Additional information regarding fiber-optic sensors can be found in the doctoral thesis of Dipl. Ing. Dr. Vivien Giesela Schlüter, “Entwicklung eines experimentell gestützten Bewertungsverfahren zur Optimierung and Charakterisierung der Dehnungsübertragung oberflächenapplizierter Faser-Bragg-Gitter-Sensoren” [Development of an Experimentally-Supported Analysis Method for Optimizing and Characterizing the Strain Transfer of Surface-Mounted Fiber Bragg Grating Sensors], available on the internet.

From EP 1 068 686 B1 (Phoenix Controls Corp.), a networked optoelectronic signal distribution system for detecting environmental variables is known, wherein the signal distribution system comprises the following components: a light source, a photo detector, and an optical distribution network for distributing light from the light source to the photo detector along at least one selected light path. The optical distribution network includes a plurality of remotely distributed optical devices reacting to at least one environmental variable which interacts with the light. According to one embodiment, FBG sensors are used. The environmental variables are, in particular, the CO2 content, VOC's (volatile organic compounds) or other gaseous components, bacterial agents, temperature, moisture, air velocity, and air pressure. Moreover, remotely distributed switches for specifically connecting the optical devices to the optical distribution network are provided. The transmission network is designed such that the light from the light source and the light affected by the at least one environmental variable are transmitted along the same light path. Based upon the output signal of the photo detector, a processor generates information about the respective environmental variable to be detected.

From EP 1 826 545 A1 (Fuji) is known a device for measuring state variables by means of at least one fiber-optic sensor; the device is, in particular, a damage detection system. The device uses an optical waveguide, which is installed in or on a mechanical component. The optical waveguide comprises a plurality of FBG's. Each fiber Bragg grating reflects a portion of an optical input signal guided in the optical waveguide. Under the influence of a mechanical stress, the length of the optical waveguide, and thus the grating constant of the fiber Bragg grating, changes. As a consequence of the change in the grating constant, the wavelength of the reflected portion of the optical input signal also changes. By analyzing the reflected portion, or the optical output signals, conclusions regarding the load and/or the temperature of the mechanical component can be drawn. In order to generate the input signal and to analyze the output signal, a broadband light source, an optical circulator, and an arrayed waveguide grating are used. The components are assembled as discrete elements with known optical plug connectors or splice connections.

The known solution is mechanically less robust with respect to signal generation and signal analysis. Moreover, the space requirements and energy consumption are comparatively high, so that the known device can only be produced and operated at high cost.

From WO 2006/079466 A1 (Bayer) is known a spectroscopic arrangement consisting of at least one light source for Bragg grating fibers and an NIR measuring cell, at least one optical multiplexer for connecting various measuring sections to a spectrometer, at least one FBG fiber and at least one glass fiber for NIR spectroscopy, an interferometer, a detector, and a signal analysis/control unit. Via the signal analysis/control unit, the spectrometric determination of the concentration by means of the NIR measuring cell, on the one hand, and the spectrometric determination of the temperature or of the temperature profile by means of the FBG fiber, on the other, take place. The interferometer of a Fourier transform spectrometer is arranged between the output of the measuring sections and the detector.

Additional solutions regarding fiber-optic sensors and their use are also known from the following patent applications: DE 10 2012 221 067 A1, DE 102012 214 441 A1, DE 10 2012 222 460 A1, DE 10 2010 001 197 A1, and DE 10 2013 205 205 A1 (inventor: Prof. Schade, among others).

DE 10 2011 017 622 B3 (inventor: Prof. Schade, among others) describes a fiber-optic device for measuring state variables and its application, which device requires little installation space, can be produced easily and cost-effectively, and can be used. The device consists of a coupler or optical waveguide, at least one filter element or a fiber Bragg grating inscribed into the coupler, and at least one photoelectric converter. In the known solution, the optical coupler, the filter element, and the photoelectric converter and possibly also an evaluating unit are arranged on a substrate. The device allows for forces, mechanical stresses, and/or temperatures acting on mechanical components to be determined by the change in the grating constant of at least one fiber Bragg grating. The mechanical component consists of either a fiber-reinforced plastic, a metal, or an alloy. The light source preferably emits a broadband optical signal, so that a plurality of fiber Bragg gratings with different grating constants can be read. The portion of the optical input signal reflected by the at least one fiber Bragg grating is filtered by at least one passive optical component and converted into an electrical signal by a photoelectric converter. The electrical signal is fed to an evaluation circuit.

Even though the known solution requires little space, it can be used to only a limited extent in applications of process automation. In biochemical and pharmaceutical processes, the development tends toward the use of single-use containers and/or small batches. In the case mentioned first, the known device with its integrated electric and electronic components must be disposed of together with the container, which entails additional costs, since an appropriate device must be produced for each container, or the device must be cleaned and, where applicable, sterilized, which also entails additional costs, since cleaning/sterilization is expensive, and/or the device must be designed for cleaning/sterilization. In addition, electric/electronic components cannot be gamma sterilized. Similar problems occur when the known device is to be used in a process in which radioactive radiation occurs.

### SUMMARY

The present disclosure is based upon the aim of proposing a cost-effective system for determining a process variable of a medium in automation technology.

The aim is achieved by a system for determining at least one process variable of a medium arranged in a container. The container is, for example, any tank, a pipeline, a fermenter, or a single-use or disposable container. The system comprises at least one optical fiber Bragg sensor with an optical waveguide with at least one fiber Bragg grating, and at least one signal generating unit designed such that it generates at least one optical input signal and couples it into the at least one optical waveguide. The input signal(s) is/are either a broadband optical input signal or narrow-band input signals adapted to the measuring tasks of the fiber Bragg sensors and, in particular, to the fiber Bragg grating. The system furthermore comprises a receiving unit, which is preferably a photoelectric converter. The receiving unit is designed such that it receives at least one optical output signal from the at least one optical waveguide and converts it into an electrical output signal. An evaluating unit is, moreover, provided, which determines the at least one process variable based upon the at least one electrical output signal. Evaluation possibilities have already been mentioned in the description introduction.

According to the present disclosure, at least one subsection of the at least one optical waveguide is arranged inside the container or in the wall of the container. The subsection of the at least one optical waveguide is designed such that the at least one fiber Bragg grating is affected by the at least one process variable to be determined of the medium. The subsection can be shaped in any way for example, as straight, meander-shaped, or curved. It can be conducted with one or both end regions through the wall of the container or, depending upon the design, even end there. Naturally, a bundle of optical waveguides can also be used, instead of a single optical waveguide.

The medium is preferably a fluid medium in particular, a gas, a gas mixture, a liquid, a granulate, or a powder.

The optical fiber Bragg sensor is furthermore designed such that it determines, in particular, at least one of the following physical or chemical process variables: temperature, pressure, fill-level, flow rate, mechanical stresses, interfering vibrations, pH value, turbidity, concentration of a substance, an atomic or molecular gas, or a portion of at least one gaseous, liquid, or solid component. In addition, the optical fiber Bragg sensor can be designed such that it determines the color of the medium, or be designed such that it determines at least one metabolite or the concentration of a metabolite, wherein a metabolite is an intermediate product in a biochemical metabolic process. Exemplary solutions of various fiber Bragg sensors have already been cited in the description introduction.

The solution according to the present disclosure is very well suited for use in process automation. As already mentioned, the development particularly in the case of biochemical and pharmaceutical processes tends toward the use of single-use containers and/or small batches. As described below in connection with preferred embodiments, with the present disclosure, it is possible, after fulfilling the measuring or monitoring task, to remove, without difficulty, the optical waveguide from the container and to subsequently clean/sterilize it, to clean/sterilize the optical waveguide with the container, or to leave the at least one optical waveguide in the container and dispose of it with the container. Even a gamma sterilization of the at least one optical waveguide with or without the container is possible, if the materials are suitably selected. The same applies if the at least one optical waveguide is used in a process in which a high risk potential for example, as a consequence of radioactive radiation prevails. Another advantage of the solution is to be seen in that the electronic components can be located remotely from the process (for example, in a control room), since the transmission of the light via the optical waveguide takes place almost without loss.

According to an advantageous embodiment, the optical waveguide consists of a core and a cladding at least partially surrounding the core. In order to ensure that the light propagates mainly in the core, the core material has a higher refraction index than the cladding material.

Alternatively, and/or adapted to the process variable to be determined, the optical waveguide consists of a fiber, wherein the fiber material has a higher refraction index than the medium affecting the at least one fiber Bragg grating.

It is considered to be particularly advantageous in connection with the system according to the present disclosure if the optical waveguide contains fiber Bragg grating groups at defined intervals, wherein a fiber Bragg grating group is designed such that at least two different process variables can be determined selectively. According to the present disclosure, a multi-sensor is thus provided.

It is furthermore provided that the optical waveguide be designed such that at least one fiber Bragg grating or at least one fiber Bragg grating of the fiber Bragg grating group interacts with the medium via an evanescent field for the purposes of determining a process variable of the medium. Evanescence is understood to mean that electromagnetic waves penetrate a material in which they cannot propagate, and then ‘disappear’ in the material exponentially. From DE 10 2014 220 040 A1 (Boston University, Frauenhofer, inventor: Prof. Schade, among others), a fiber-optic sensor has become known, which contains a fiber Bragg grating. The fiber-optic sensor contains an optical waveguide with a core and a cladding, wherein the cladding is removed in the region of the fiber Bragg grating. The fiber-optic sensor can be immersed in gases or liquids, wherein the Bragg wavelength reflected by the fiber Bragg grating changes as a function of the refraction index or the refractive index of the medium surrounding the sensor. In order to enhance this effect and to increase the resolution of the fiber-optic sensor, DE 10 2014 220 040 A1 proposes a device for determining a refractive index or a hydrophone (underwater microphone), in which the cladding of the optical waveguide is removed at least partially in at least a first longitudinal section. The core contains at least one fiber Bragg grating in at least a second longitudinal section. At least a partial surface of the surface in the first longitudinal section is provided with nanoparticles. In addition to the Bragg wavelength, the intensity is also measured. An acoustic signal can thus be detected, effectively, twice. It goes without saying that the Bragg sensor used in connection with the system according to the present disclosure can be structured accordingly.

An advantageous embodiment of the system according to the present disclosure proposes that a surface layer be applied to the optical waveguide at least in a subregion, wherein the surface layer is designed such that the at least one fiber Bragg grating has an increased sensitivity to the respective process variable to be measured. Nanoparticles are used for the surface layer, for example.

An advantageous development of the system according to the present disclosure provides that a duct for the at least one optical waveguide be provided in a wall of the container, wherein the duct is designed such that at least one of the two end regions of the at least one optical waveguide is led out of the container. The duct is designed such that the internal space of the container is sealed off from the external space. The optical waveguide is mounted in the duct either removably or non-removably.

An alternative embodiment provides that there be, in a wall of the container, a coupling component designed such that at least one of the two end regions of the at least one optical waveguide is connected or connectable to the coupling element.

Another alternative proposes that at least one coupling region be provided in the wall of the container, wherein the coupling region is designed as a window transparent to the optical input and output signal(s). At least one of the two end regions of the at least one optical waveguide is connected or connectable to at least one optical component in particular, a lens system. An advantage of this embodiment is to be seen in that a mechanical decoupling exists between the optical waveguide arranged in the container and the electronic components.

In connection with the solution according to the present disclosure, it is further proposed that the at least one optical waveguide with the at least one fiber Bragg grating be arranged at least partially on a substrate or be integrated at least partially into a substrate. It is preferably provided that the wall of the container be at least partially produced from the substrate or coated with the substrate. It is further suggested that the receiving unit which is a photoelectric converter, for example and/or the evaluating unit be arranged on the substrate or integrated into the substrate.

According to an advantageous development of the system according to the present disclosure, the signal generating unit and the receiving/evaluating unit, and thus the sensitive electronic/electric components of the system, are arranged outside the container and thus outside the process.

According to an advantageous embodiment of the system according to the present disclosure, a control system is provided, to which the evaluating unit is connected for communication. The communication can take place in a wired manner, or wirelessly by radio.

In order to be able to be used in all applications of automation technology without restrictions, the power of the optical input signals coupled into the at least one optical waveguide is dimensioned such that it is less than the maximum power permissible for an explosion-hazard area. For the case in which not only the optical waveguide, but also the electric/electronic components of the system are arranged in the explosion-hazard area, the components are designed such that the power for operating the components is less than the maximum power permissible for the explosion-hazard area.

### BRIEF DESCRIPTION OF THE DRAWINGS

The present disclosure is explained in greater detail with reference to the following figures. Illustrated are:

FIG. 1A shows a schematic illustration of a first embodiment of the system according to the present disclosure;

FIG. 1B shows the section A shown in FIG. 1A, in an enlarged illustration;

FIG. 2A shows a schematic illustration of an embodiment of the fiber Bragg sensor; and

FIG. 2B shows the section B shown in FIG. 2A, in an enlarged illustration.

### DETAILED DESCRIPTION

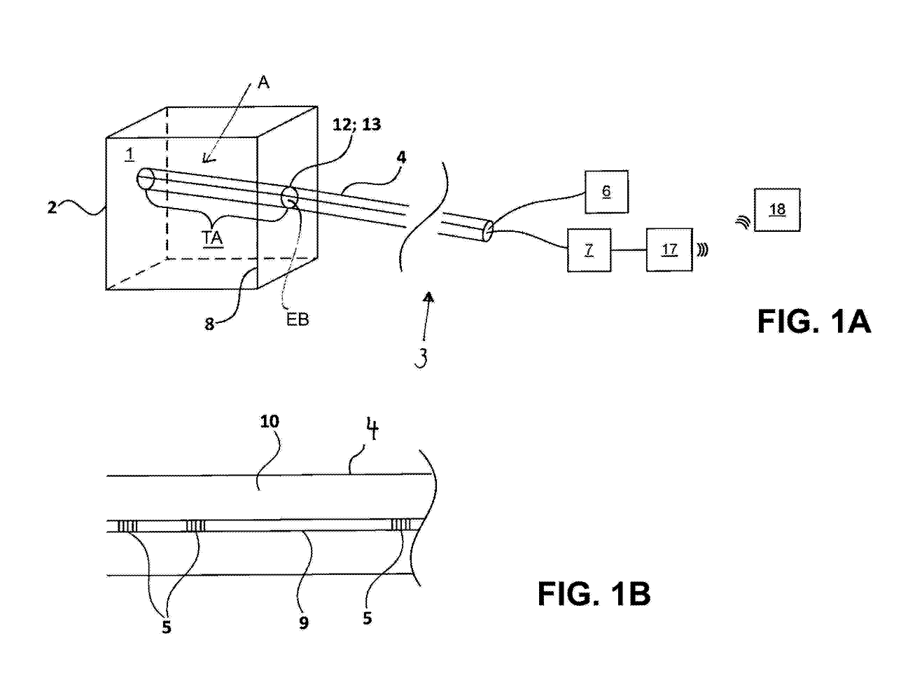

FIG. 1A shows a schematic illustration of a first embodiment of the system according to the present disclosure for determining and/or monitoring at least one process variable of a medium 1 arranged in a container 2. In the case shown, the container 2 is a bag-shaped, flexible container, such as a single-use or disposable bag. It goes without saying that the present disclosure can be used in connection with all possible containers 2.

The system according to the present disclosure comprises an optical fiber Bragg sensor 3 with an optical waveguide 4, which comprises at least one fiber Bragg grating 5 serving as filter element. As can be seen in FIG. 1B, the optical waveguide consists of a core 9 and a cladding 10. The cladding 10 surrounds the core 9 at least partially. So that the electromagnetic input signals or the light propagate in the core 9 with as little a loss as possible, the material of which the core 9 consists has a higher refraction index than the material of which the cladding 10 consists.

A subsection TA of the optical waveguide 4 is arranged in the container 2. In an alternative not shown separately, the optical waveguide 4 is arranged in the wall 8 of the container 2 and is thus an integral part of the container 2. The subregion TA of the optical waveguide 4 extending in the internal space or in the interior of the container 2, or the subregion TA of the optical waveguide 4 interacting with the medium 1, is designed such that the at least one fiber Bragg grating 5 (in the case shown, a group of two fiber Bragg gratings 5 and a single fiber Bragg grating 5 are shown) is affected by the at least one process variable to be determined of the medium 1. The fiber Bragg grating groups or fiber Bragg gratings 5 arranged at defined intervals in the optical waveguide 4 are designed such that at least two different process variables can be determined selectively. Various designs of fiber Bragg sensors 3 for determining or monitoring different process variables have already previously been described and are disclosed in the cited prior art in detail.

The signal generating unit 6 preferably, a broadband light source generates at least one optical input signal and couples it into the optical waveguide 4. Furthermore, a receiving unit 7 is provided, designed such that it receives at least one optical wavelength-coded output signal from the one optical waveguide 4 and converts it into an electrical output signal. Based upon the at least one electric output signal, an evaluating unit 17 determines the at least one process variable.

In the embodiment of the system according to the present disclosure shown in FIG. 1A, the electrical/electronic components, signal generating unit 6, receiving unit 7, and evaluating unit 17 are arranged outside the container 2. The optical waveguide 4 is connected in a fixed or removable manner to the container 2 via a duct 12 or a coupling component 13. Evaluating units for determining or monitoring the process variable(s) are known from the prior art. In the case shown, the evaluating unit 17 communicates with a remotely arranged control room 18 by radio. Naturally, wired communication is also possible. Alternatively, all or at least a portion of the electric/electronic components 6, 7, 17 can be arranged remotely from the container 2 at any distance, by dimensioning the optical waveguide 4 accordingly. As already mentioned previously, it is also known to operate a plurality of optical waveguides 4 via corresponding connections by means of, for example, only one signal generating unit 6, receiving unit 7, and evaluating unit 17. The process variables of various containers 2 or batches can thus be determined and monitored simultaneously by one evaluating unit 17.

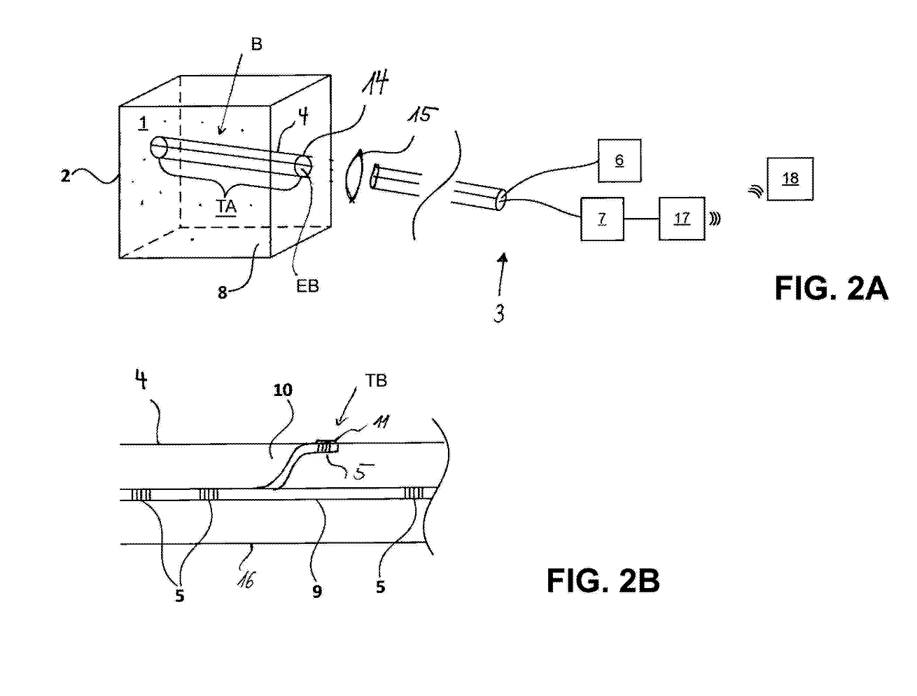

FIG. 2A shows a schematic illustration of an embodiment of the system according to the present disclosure for determining and/or monitoring at least one process variable of a medium 1 arranged in a container 2. Below, reference is made only to the system components in which the embodiment shown in FIG. 2A differs from the embodiment shown in FIG. 1A.

As can be seen in FIG. 2B, which shows the section marked B in FIG. 2A in an enlarged illustration, the subsection TA of the optical waveguide 4 arranged in the container 2 is designed such that at least one fiber Bragg grating 5 interacts with the medium 1 via an evanescent field for the purposes of determining a process variable of the medium 1. In the case shown, in the subregion TB, a surface layer 11 is mounted onto the optical waveguide 4. The surface layer 11 is optional and designed such that the at least one fiber Bragg grating 5 has an increased sensitivity to the process variable to be measured or monitored.

The subsection TA of the optical waveguide 4 arranged in the container 2 is connected with its end region EB to the coupling region 14. This coupling region 14 is designed such that it is transparent to the radiation or the light conducted in the optical waveguide 4. The optical coupling of the light between the subsection TA of the optical waveguide 4 in the container 2 and the optical waveguide 4 outside the container 2 takes place via at least one optical component 15, such as a lens. As already mentioned, the subsection TA can, depending upon the measuring or monitoring task, be arranged on or in a substrate 16.

Claimed is:

1. A system for determining at least one process variable of a medium arranged in a container, comprising:
an optical fiber Bragg sensor with an optical waveguide including at least one fiber Bragg grating, which is configured to be affected by the at least one process variable of the medium to be determined;
a signal generating unit embodied to generate an optical input signal and to couple the input signal into the optical waveguide;
a receiving unit embodied to receive an optical output signal from the optical waveguide and to convert the optical output signal into an electrical output signal; and
an evaluating unit configured to determine the at least one process variable based upon the electrical output signal,
wherein a subsection of the optical waveguide is disposed within the container or in or adjacent a wall of the container, and wherein the subsection of the optical waveguide includes the at least one fiber Bragg grating arranged to interact with the medium.

2. The system of claim 1, wherein the optical waveguide includes a core and a cladding surrounding the core at least partially, wherein the core is composed of a material having a higher refraction index than a material of the cladding.

3. The system of claim 1, wherein the optical waveguide includes of a fiber having a higher refraction index than the medium interacting with the at least one fiber Bragg grating.

4. The system of claim 1, wherein the optical waveguide includes Bragg grating groups at defined intervals, wherein a fiber Bragg grating group is configured such that at least two different process variables can be determined selectively.

5. The system of claim 1, wherein the optical waveguide is embodied such that at least one fiber Bragg grating or at least one fiber Bragg grating of a fiber Bragg grating group interacts with the medium via an evanescent field to enable determining the at least one process variable of the medium.

6. The system of claim 1, wherein the optical waveguide includes a surface layer in a subregion of the optical waveguide, wherein the surface layer is embodied to increase a sensitivity of the at least one fiber Bragg grating to the the at least one process variable of the medium to be determined.

7. The system of claim 1, wherein a wall of the container includes a duct configured such that at least one of two end regions of the optical waveguide extends out of the container.

8. The system of claim 1, wherein a wall of the container includes a coupling component configured such that at least one of two end regions of the at least one optical waveguide is connected or connectable to the coupling component.

9. The system of claim 1, wherein the wall of the container includes at least one coupling region embodied as a window transparent to the optical input signal and optical output signal, and wherein at least one of two end regions of the at least one optical waveguide is connected or connectable to a lens system.

10. The system of claim 1, wherein the optical waveguide is arranged at least partially on a substrate or is integrated at least partially into a substrate.

11. The system of claim 10, wherein the substrate is at least a portion of a wall of the container or is a coating on a wall of the container.

12. The system of claim 10, wherein the receiving unit is disposed on the substrate or integrated into the substrate.

13. The system of claim 1, wherein the receiving unit is a photoelectric converter.

14. The system of claim 1, wherein the signal generating unit, the receiving unit and/or the evaluating unit are diposed outside the container.

15. The system of claim 1, further comprising a control system configured to communicate with the evaluating unit, the communication being wired or wireless.

16. The system of claim 1, wherein the container is a single-use or disposable container.

17. The system of claim 1, wherein the medium is a fluid medium, including a gas, gas mixture, liquid, granulate and/or powder.

18. The system of claim 1, wherein the optical fiber Bragg sensor is embodied to determine at least one of the following physical or chemical process variables: temperature, pressure, fill-level, flow rate, mechanical stress, pH value, turbidity, concentration of a substance, an atomic or molecular gas, or a portion of at least one gaseous, liquid, or solid component.

19. The system of claim 1, wherein the optical fiber Bragg sensor is embodied to determine the color of the medium.

20. The system of claim 1, wherein the optical fiber Bragg sensor is embodied to determine at least one metabolite or the concentration of a metabolite, wherein the metabolite is an intermediate product in a biochemical metabolic process.

21. The system of claim 1, wherein the optical input signal is coupled into the optical waveguide at a power that is less than the maximum power permissible for an explosion-hazard area.

22. The system of claim 1, wherein the system is powered at a power that is less than the maximum power permissible for the explosion-hazard area.
